(19) United States
(12) Patent Application Publication
(10) Pub. No.: US 2005/0094193 A1
(43) Pub. Date: May 5, 2005

(54) Print driver system and method for print job notification

(75) Inventor: Tommy Lee Oswald, Tigard, OR (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/700,427

(22) Filed: Nov. 4, 2003

(51) Int. Cl. G06F 15/00

(52) U.S. Cl. 358/1.15; 358/402

(57) ABSTRACT

A print driver system and method are provided for print job notification. The method comprises: accepting a document at a print driver; presenting a user interface (UI) for accepting print job commands, such as the selection of a printer; presenting a UI for receiving notification commands, such as a text message of email address; sending the document for printing in response to the print job commands; and, sending a print job notification to an email address, in response to sending the document for printing. The print job notification can be for the purpose of reporting errors, a completed print job, the identity of the selected printer, or instructions to be carried out regarding the completed print job.

### BACKGROUND OF THE INVENTION

1. Field of the Invention

This invention generally relates to digital document processing and, more particularly, to a system and method for providing print job notification, using a print driver.

2. Description of the Related Art

In a large organization, a printing task may be distributed between multiple parties. For example, a first person may send a document to a printer for printing, but it may be the responsibility of a different person to deliver the printed documents. As another example, the first person may send a print job to a printer in a remote location, and rely upon another party to collect the documents from the printer. Internet printing protocol (IPP) presently addresses this issue with the use of a subscription object. A subscription object can be attached to a job object, to deliver notification upon job completion, or errors to an IPP client running on a host. The notification may also include additional text with instructions. IPP has the following problems:

1. An IPP printer object needs to be implemented in the product, and an IPP client needs to be installed on a host that is to receive the notifications. Developing an IPP printer object for a multifunctional peripheral (MFP) is not a small task. It cannot be done quickly, often times not within the time limits of a product's development cycle. IPP requires an asserted effort that is costly in man-hours, with further time spent in integration.

2. IPP requires a HTTP 1.1 compliant transport that can listen to port 631 on the MFP and the client host computer. In other words, another protocol needs to be implemented, which in turn, implements the IPP.

3. Further, the recipient of the notification must be running an IPP client to receive the notification. It is not sent via email.

It would be advantageous if there were a simple process to send print job notifications that avoided the above-mentioned problems associated with IPP.

### SUMMARY OF THE INVENTION

The present invention solves the print job notification problem on a per job basis. Notification of errors and job completion are sent via email to an individual, instructing the individual in what is needed to complete any auxiliary tasks associated with a print job. The invention permits an email to be used to communicate any message pertinent to the completion of the print job.

Accordingly, a print driver method is provided for print job notification. The method comprises: accepting a document at a print driver; presenting a user interface (UI) for accepting print job commands, such as the selection of a printer; presenting a UI for receiving notification commands, such as a text message of email address; sending the document for printing in response to the print job commands; and, sending a print job notification to an email address, in response to sending the document for printing. The print job notification can be for the purpose of reporting errors, a completed print job, the identity of the selected printer, or instructions to be carried out regarding the completed print job.

Presenting a UI for receiving notification commands may include presenting: a graphical UI (GUI) tab to enable the notification feature; an address box for entry of an email address; and/or, a text box for entry of a text message. Further, the UI may present selection tabs for features such as staple, hole punch, document delivery time, and document delivery location.

In some aspects, the email notification may be relayed through the printer performing the print job, with the substeps of: sending the notification to a printer, bundled with the document to be printed; and, sending the notification as an email from the printer, to a destination. In this aspect, the notification may be bundled with the document and selected job attributes and sent a print subsystem associated with a print driver.

Additional details of the above-described method, and a print driver system for print job notification are provided below.

### BRIEF DESCRIPTION OF THE DRAWINGS

FIG. 1 is a schematic block diagram illustrating the present invention print driver system for print job notification.

FIG. 2 is a diagram illustrating an exemplary print driver UI.

FIG. 3 is another exemplary print driver UI.

FIG. 4 is a schematic block diagram illustrating another aspect of the present invention print notification system.

FIG. 5 is a flowchart illustrating the present invention print driver method for print job notification.

### DETAILED DESCRIPTION OF THE PREFERRED EMBODIMENTS

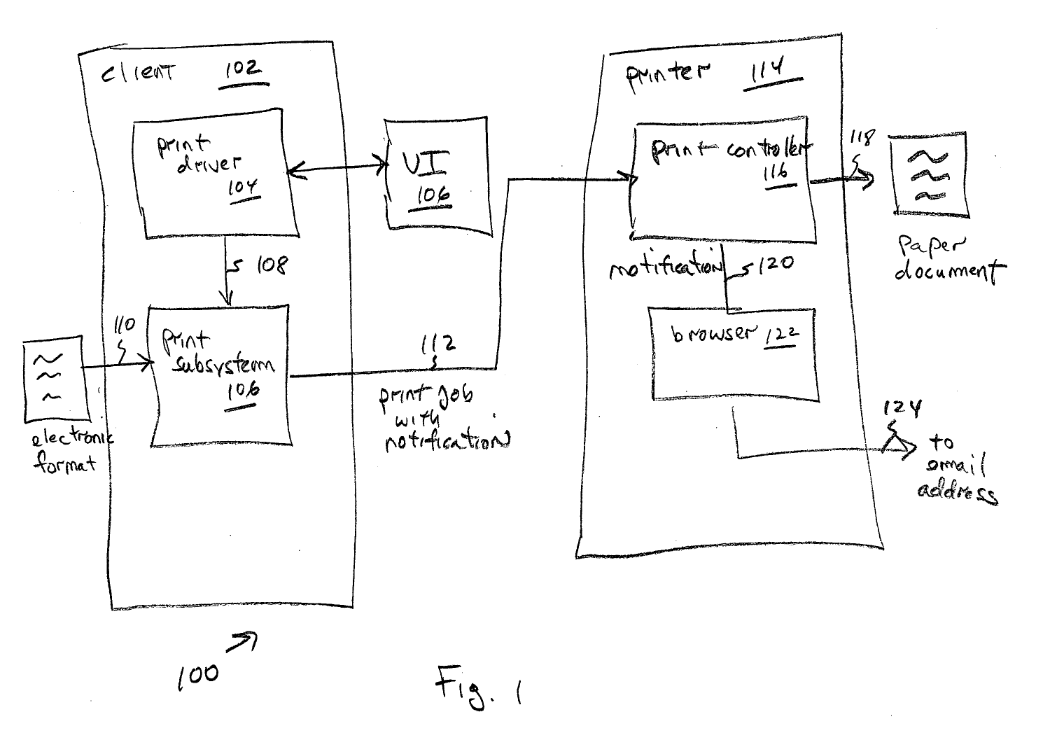

FIG. 1 is a schematic block diagram illustrating the present invention print driver system for print job notification. The system 100 comprises a client 102 including a print driver 104 and a print subsystem 106. The print driver 104 has a user interface (UI) 106 for accepting print job commands and a UI for receiving notification commands. For simplicity, both UIs are represented by reference designator 106. The print driver 104 has an interface on line 108 to supply notification-enabled print driver commands.

The print subsystem 106 has an interface on line 110 to accept a document (electronically formatted) and an interface on line 108 to accept the notification-enabled print driver commands. The print subsystem 106 has an interface on line 112 to supply the document for printing, bundled with a print job email notification. In one example, the print subsystem 106 supplies the email notification embedded in printer job language (PJL) statements. However, the invention is not limited to any particular print language or format.

A printer 114 includes a print controller 116 having an interface on line 112 to accept the bundled document for printing from the client print subsystem 106. The print controller 116 has an interface on line 118 to supply the document printed on a paper media, and an interface on line 120 to supply the print job email notification. The printer 114 also includes a browser 122 having an interface on line 120 to accept the print job email notification and a network-connected interface on line 124 to supply the print job notification to a specified email address. Note, the figure implies that the printer 114 is locally connected to the client 102. However, the client 102 and printer 114 may also be network connected, through an intervening server (not shown) for example. In one aspect, line 112 is a local area network (LAN). In another aspect, lines 112 and 124 represent a common (the same) network.

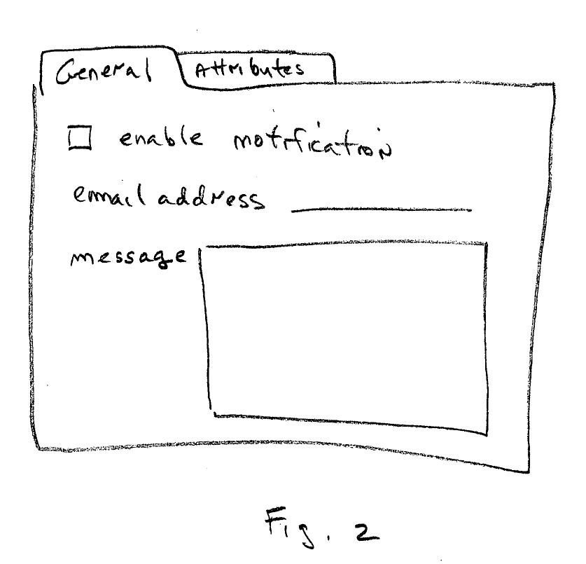

FIG. 2 is a diagram illustrating an exemplary print driver UI. As shown, the print driver UI is capable of receiving a text message and/or an email address. The data may be input by a keyboard and mouse for example. The email can be the destination to which the text message is to be sent. The print driver supplies the text message and email address in the notification-enabled print driver commands. The print driver supplies a notification, including disposition instructions for the printed document, in the notification-enabled print driver commands. As shown, the print driver UI presents a graphical UI (GUI) tab to enable the notification feature. However, other means of data entry are known in the art. In one aspect, the UI text message is the notification instructions. Alternately, specific notification instructions can be formed in a different UI.

In another aspect (not shown), the print driver UI presents a menu for the selection of a printer and supplies the selected printer identity with the print job notification in the notification-enabled print driver commands. One example of such an interface would be the print submenu, that is accessible using the “File” tab of a Microsoft Word document processing application.

Returning to FIG. 1, in another aspect of the system the printer controller 116 supplies an error message in the event of a printing error, and the printer browser 122 sends an error message notification to the specified email address. For example, a message such as “Paper Tray Error” may be sent in the event the printer runs out of paper.

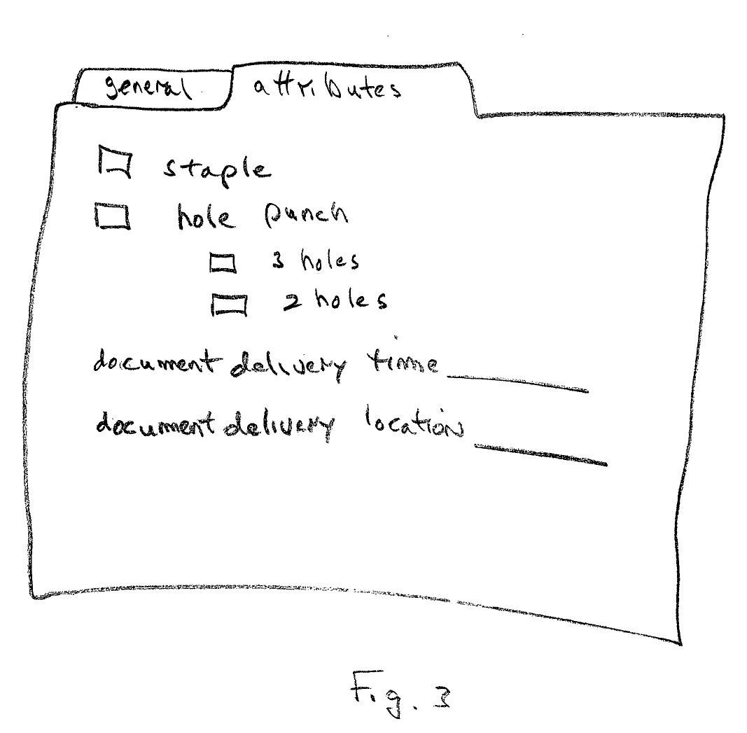

FIG. 3 is another exemplary print driver UI. This UI could be presented as a sub-tab (attributes) of the menu of FIG. 2, for example. As shown, the print driver UI presents tabs for selecting features such as staple, hole punch, document delivery time, and document delivery location. The present invention is not limited to any particular list of attributes, and other attribute selections are also possible.

### Functional Description

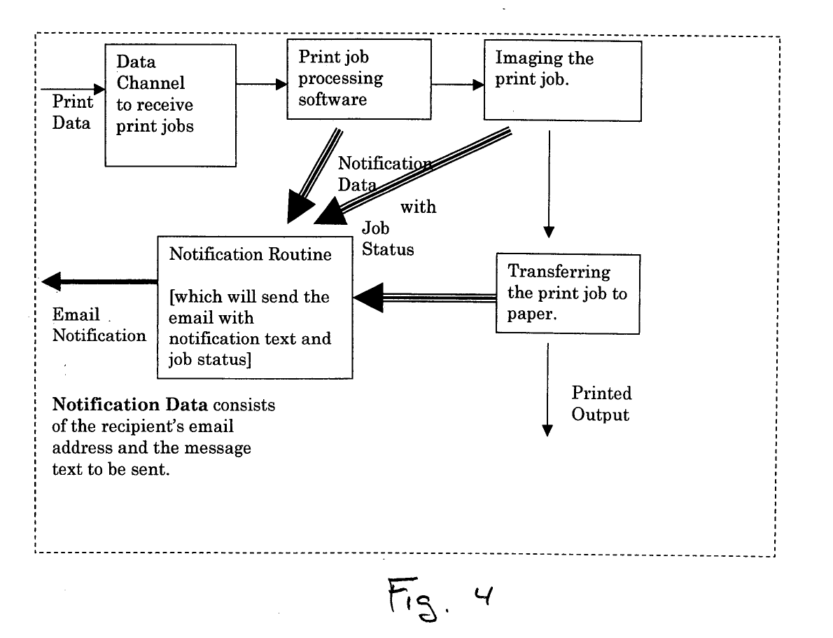

FIG. 4 is a schematic block diagram illustrating another aspect of the present invention print notification system. The present invention can be used to solve the following exemplary problem. An executive has a scheduled meeting at 1:00 P.M. and wants a secretary to deliver the print job to the meeting at a specific time, 1:30 P.M. If the executive did not have the time to print the job ahead of time, or to make arrangements with the secretary, the executive could start the print job specifying the secretary as the recipient of an email which would contain the following message: “Please go to printer x and deliver the print job to conference room B at 1:30 P.M. today”. At completion of the print job, the secretary would receive the message so that they could comply. If any errors occurred preventing the job from printing, the secretary would get the same message text with the additional error message, letting the secretary know what is preventing the print job from being completing, so that appropriate action could be taken.

The present invention provides a more convenient and time-efficient method of conferring with other individuals, and permits print job tasks to be managed on a per job basis. This invention is novel in that it uses the print driver, instead of a protocol (such as IPP) to solve the problem. The invention has the following advantages:

1. Print drivers are proprietary, and the notification feature can be leveraged as an advantage over a competitor's product.

2. It does not require the implementation and long development cycle of a complicated protocol like IPP. Rather, it can be implemented in the development cycle of a single product.

3. It sends notifications via email, so the recipient's host computer does not need to run an IPP client.

4. Conventionally, notification must be attached to an existing IPP print job. The invention has the notification accompany the print job. That is, the notification is part of the job submission.

The print driver presents the required notification information to the printer, in response to receiving the information from the user. The print driver may provide a tab (see FIG. 2) in the print GUI to present this feature to the user. Then, the user would simply press the newly added notification tab and provide the following information:

1. An enable box may be checked to enable the notification feature for the current print job.

2. A line is presented for entry of an email address.

3. A text box is presented for the entry of message/instructions pertinent to the print job.

The driver may employ any number of additional features. As an example, the print driver can add a PJL directive that enables the notification feature for the job, and provides the email address and text. In this example, the PJL would cause a routine to be called within the MFP to execute the feature upon error and/or job completion. Note, in some aspects of the invention, an email client must be resident in the MFP or printer.

The driver might supply the following PJL command:

%-12345X@PJL COMMENT <date>
@PJL SET NOTIFICATION=ON
@PJL SET NOTIFICATION EMAlL=soandso@mycompany.com
@PJL SET NOTIFICATION_MESSAGE=”When printer X finishes
printing ‘How to fix my car’, please deliver it in the middle of the
‘mechanics are us’ meeting.”
@PJL JOB NAME=”How to fix my car.txt”

.
.
. Print data
.
.

%-12345X@PJL EOJ NAME=”How to fix my car.txt”
%-12345X

The Notification information is stored with the other job attributes and is passed through the printer.

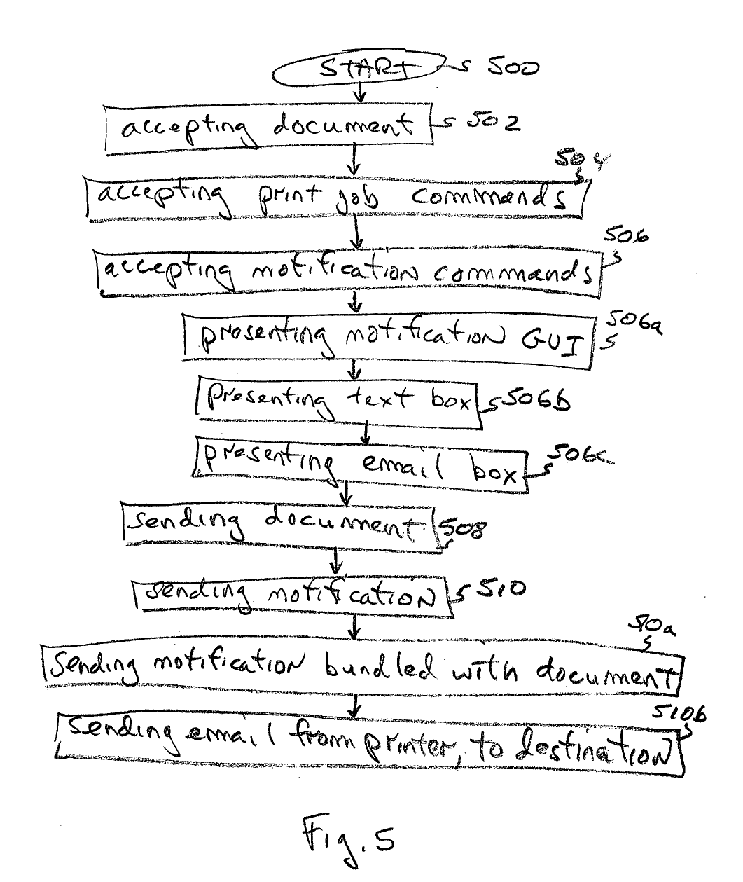

FIG. 5 is a flowchart illustrating the present invention print driver method for print job notification. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 500.

Step 502 accepts a document at a print driver. Step 504 presents a user interface (UI) for accepting print job commands. Step 506 presents a UI for receiving notification commands. Step 508 sends the document for printing in response to the print job commands. Step 510 sends a print job notification to an email address, in response to sending the document for printing.

In some aspects, sending a print job notification to an email address in Step 510 includes sending a notification for the purpose of reporting errors and/or completed print jobs. In other aspects, Step 510 sends instructions to be carried out regarding the completed print job. In another aspect, Step 510 sends an error message in the event of a printing error.

In one aspect, presenting a UI for receiving notification commands in Step 506 includes substeps. Step 506b receives a text message. Step 506c receives the email address to which the text message is to be sent. More specifically, Step 506a may present a GUI tab to enable the notification feature. Then, Step 506b may present a text box for entry of a text message and 506c may present an address box for entry of an email address.

In other aspects, Step 506 receives instructions for the disposition of the printed documents, and sending a print job notification to an email address (Step 510) includes sending the printed document disposition instructions. In another aspect, Step 506 receives the email address to which to the notification is to be sent, and Step 510 sends the notification to the email address specified in the notification commands.

In one aspect, presenting a UI for receiving notification commands (Step 506) includes presenting selection tabs for job attributes such as stapling, hole punching, document delivery time, and document delivery location.

In one aspect, presenting a UI for receiving print job commands in Step 504 includes presenting a menu for the selection of a printer. Then, sending a notification to an email address (Step 510) may include sending the identity of the selected printer.

In one aspect, sending a print job notification to an email address in Step 510 includes relaying the notification through the printer performing the print job. In this aspect, Steps 508 and 510 overlap. Then, Step 510 may include substeps. Step 510a sends the notification to a printer, bundled with the document to be printed. Step 510b sends the notification as an email from the printer, to a destination. In some aspects, presenting a UI for accepting print job commands in Step 504 includes presenting a menu for selecting a printer, job attributes, and an email address. Then, Step 510a sends the notification bundled with the document and selected job attributes, to the specified printer. Step 510b sends the notification from the specified printer to the destination with the specified email address.

In other aspects, sending the notification bundled with the document and selected job attributes in Step 510a includes sending the notification through a print subsystem associated with the print driver. For example, the notification can be sent through the print subsystem embedded in printer job language (PJL) statements.

A system and method have been provided for print driver print job notification. Examples have been given of notification messages and menu formats, but the invention is not limited to these examples. Although the invention has generally been explained in the context of a Microsoft Windows operating system, the invention can also be practiced with an Apple MacIntosh Operating System, Linux Operating System, System V Unix Operating Systems, BSD Unix Operating Systems, OSF Unix Operating Systems, Sun Solaris Operating Systems, HP/UX Operating Systems, or IBM Mainframe MVS and AS/400 Operating System, to name a limited list of other possibilities. Other variations and embodiments of the invention will occur to those skilled in the art.

1. A print driver method for print job notification, the method comprising:
at a print driver, accepting a document;
presenting a user interface (UI) for accepting print job commands;
presenting a UI for receiving notification commands;
sending the document for printing in response to the print job commands; and,
sending a print job notification to an email address, in response to sending the document for printing.

2. The method of claim 1 wherein sending a print job notification to an email address includes sending a notification for the purpose of reporting errors and completed print jobs.

3. The method of claim 1 wherein presenting a UI for receiving notification commands includes:
receiving a text message; and,
receiving the email address to which the text message is to be sent.

4. The method of claim 3 wherein sending a print job notification to an email address includes sending instructions to be carried out regarding the completed print job.

5. The method of claim 4 wherein presenting a UI for receiving print job commands includes presenting a menu for the selection of a printer; and,
wherein sending a notification to an email address includes sending the identity of the selected printer.

6. The method of claim 4 wherein presenting a UI for receiving notification commands includes receiving instructions for the disposition of the printed documents; and,
wherein sending a print job notification to an email address includes sending the printed document disposition instructions.

7. The method of claim 4 wherein presenting a UI for receiving notification commands includes receiving the email address to which to the notification is to be sent; and,
wherein sending a print job notification to an email address includes sending the notification to the email address specified in the notification commands.

8. The method of claim 4 wherein sending a print job notification to an email address includes sending an error message in the event of a printing error.

9. The method of claim 4 wherein presenting a UI for receiving notification commands includes presenting:
a graphical UI (GUI) tab to enable the notification feature;
an address box for entry of an email address; and,
a text box for entry of a text message.

10. The method of claim 4 wherein presenting a UI for receiving notification commands includes presenting selection tabs for job attributes chosen from the group including staple, hole punch, document delivery time, and document delivery location.

11. The method of claim 1 wherein sending a print job notification to an email address includes relaying the notification through the printer performing the print job.

12. The method of claim 11 wherein relaying the notification through the printer performing the print job includes:
sending the notification to a printer, bundled with the document to be printed; and,
sending the notification as an email from the printer, to a destination.

13. The method of claim 12 wherein presenting a UI for accepting print job commands includes presenting a menu for selecting a printer, job attributes, and email address; and,
wherein sending the notification to a printer, bundled with the document to be printed includes sending the notification bundled with the document and selected job attributes, to the specified printer; and,
wherein sending the notification as an email from the printer, to a destination, includes sending the notification from the specified printer to the destination with the specified email address.

14. The method of claim 13 wherein sending the notification bundled with the document and selected job attributes includes sending the notification through a print subsystem associated with the print driver.

15. The method of claim 14 wherein sending the notification through the print subsystem includes embedding the notification in printer job language (PJL) statements.

16. A print driver system for print job notification, the system comprising:
a client including:
a print driver with a user interface (UI) for accepting print job commands, a UI for receiving notification commands, and an interface to supply notification-enabled print driver commands; and,
a print subsystem having an interface to accept a document, an interface to accept the notification-enabled print driver commands, and an interface to supply the document for printing, bundled with a print job email notification.

17. The system of claim 16 further comprising:
a printer including:
a print controller having an interface to accept the bundled document for printing from the client print subsystem, an interface to supply the document printed on a paper media, and an interface to supply the print job email notification; and,
a browser having an interface to accept the print job email notification and a network-connected interface to supply the print job notification to a specified email address.

18. The system of claim 16 wherein the print driver UI receives a text message and an email address, to which the text message is to be sent, and supplies the text message and email address in the notification-enabled print driver commands.

19. The system of claim 18 wherein the print driver supplies a notification, including disposition instructions for the printed document, in the notification-enabled print driver commands.

20. The system of claim 19 wherein the print driver UI presents a menu for the selection of a printer and supplies the selected printer identity with the print job notification in the notification-enabled print driver commands.

21. The system of claim 17 wherein the printer controller supplies an error message in the event of a printing error; and,
wherein the printer browser sends an error message notification to the specified email address.

22. The system of claim 19 wherein the print driver UI presents:
a graphical UI (GUI) tab to enable the notification feature;
an address box for entry of an email address; and,
a text box for entry of a text message.

23. The system of claim 19 wherein the print driver UI presents tabs for selecting features chosen from the group including staple, hole punch, document delivery time, and document delivery location.

24. The system of claim 16 wherein the print subsystem supplies the email notification embedded in printer job language (PJL) statements.
